(19) United States
(12) Patent Application Publication
(10) Pub. No.: US 2025/0390848 A1
(43) Pub. Date: Dec. 25, 2025

(54) CONSUMABLE COMPONENT CONSUMING DEVICE, SYSTEM INCLUDING THE SAME, AND EXTERNAL TERMINAL

(71) Applicant: BROTHER KOGYO KABUSHIKI KAISHA, Nagoya (JP)

(72) Inventor: Shunsuke MINAMIKAWA, Nagoya (JP)

(73) Assignee: BROTHER KOGYO KABUSHIKI KAISHA, Nagoya (JP)

(21) Appl. No.: 19/247,546

(22) Filed: Jun. 24, 2025

(30) Foreign Application Priority Data
Jun. 24, 2024 (JP) 2024-101388

(51) Int. Cl. G06Q 10/30; B41J 2/175; G06Q 30/0208

(52) U.S. Cl. CPC G06Q 10/30; B41J 2/1752; G06Q 30/0208

(57) ABSTRACT

A consumable component consuming device includes a mounting unit that allows a consumable component to be detachably mounted, a display unit, and a control unit. The control unit controls the display unit to display pre-enrollment reward information. This information indicates rewards that can be granted based on consumable components collected before the user enrolls in a reward granting service. The service grants rewards in accordance with collection of the consumable component for recycling. This configuration helps encourage user enrollment by showing the value of past recycling activities.

### REFERENCE TO RELATED APPLICATIONS

This application claims priority from Japanese Patent Application No. 2024-101388 filed on Jun. 24, 2024. The entire content of the priority application is incorporated herein by reference.

### BACKGROUND ART

The present disclosure relates to a consumable component consuming device, a system including such a consumable component consuming device, and an external terminal configured to connect to the consumable component consuming device.

A consumable component consuming device has been known. An example of such a device is an inkjet printer configured to form images on a recording medium by consuming ink stored in an ink cartridge. In recent years, consumable components such as ink cartridges used in such inkjet printers have been collected by manufacturers or recycling service providers after being used up and have been recycled. Further, from the viewpoint of promoting recycling, systems have been provided in which incentives are granted to users who cooperate in the collection of consumable components.

For example, it has conventionally been known to provide a system in which a user who has registered in advance by accessing a collection center system is granted incentives in accordance with the collection of consumable components associated with the user.

### SUMMARY

However, a user does not necessarily have consumable components to be collected only after completing user registration. In some cases, a user may have consumable components collected without registering, without knowing that incentives would be granted upon registration. Nevertheless, according to the conventional configuration as described above, incentives (rewards) are not granted for consumable components collected before user registration is completed. As a result, users are unable to receive incentives corresponding to consumable components collected prior to registration, which could lead to user dissatisfaction.

According to aspects of the present disclosure, there is provided a consumable component consuming device, which includes a mounting unit configured to detachably mount a consumable component, a display unit, and a control unit. The control unit is configured to cause the display unit to display pre-enrollment reward information indicating rewards that are grantable in accordance with the consumable components collected prior to an enrollment of a user in a reward granting service to grant a reward based on collection of the consumable component for recycling.

According to aspects of the present disclosure, there is provided an external terminal connectable to a consumable component consuming device comprising a mounting unit configured to detachably mount a consumable component. The external terminal includes a terminal-side display unit, and a terminal-side control unit. The terminal-side control unit is configured to cause the terminal-side display unit to display pre-enrollment reward information indicating rewards that are grantable in accordance with consumable components collected prior to an enrollment of a user in a reward granting service to grant a reward based on collection of the consumable component for recycling.

According to aspects of the present disclosure, there is provided a consumable component management system including a consumable component consuming device and a server. The consumable component consuming device includes a mounting unit configured to allow a consumable component to be detachably mounted, a device-side control unit, and a device-side storage unit. The server includes a server-side control unit and a server-side storage unit. The device-side control unit stores first unique identification information of the consumable component mounted on the mounting unit in the device-side storage unit. The server-side control unit obtains second unique identification information of the consumable component collected for recycling. When the second unique identification information corresponds to unique identification information of a consumable component associated with a consumable component consuming device of a user enrolled in a reward granting service that grants a reward based on collection of the consumable component for recycling, the reward is granted to the user. When the second unique identification information does not correspond to such information associated with an enrolled user, the second unique identification information is stored in the server-side storage unit. After the consumable component consuming device and the server are communicatively connected, the server obtains the first unique identification information from the device-side storage unit. When the first unique identification information matches the second unique identification information stored in the server-side storage unit, the server stores, in the server-side storage unit, pre-enrollment reward information. The pre-enrollment reward information indicates rewards that are grantable in accordance with the consumable component identified by the first unique identification information, as a consumable component collected for recycling by the user of the consumable component consuming device, if the user subsequently enrolls in the reward granting service.

According to aspects of the present disclosure, there is provided a consumable component management system including a consumable component consuming device and a server. The consumable component consuming device includes a mounting unit configured to allow a consumable component to be detachably mounted. The consumable component has a consumable component storage that stores unique identification information of the consumable component. The consumable component consuming device also includes a device-side control unit. The server includes a server-side control unit and a server-side storage unit. When the consumable component is mounted on the mounting unit, the device-side control unit stores unique identification information of the consumable component consuming device in the consumable component storage of the mounted consumable component. The server-side control unit obtains, from the consumable component storage of a consumable component collected for recycling, the unique identification information of the consumable component and the unique identification information of the device. When the obtained device identification information corresponds to device identification information associated with a consumable component consuming device of a user enrolled in a reward granting service that grants rewards based on collection of consumable components for recycling, the server grants the reward to the user. When the obtained device identification information does not correspond to any device identification information associated with a user enrolled in the reward granting service, the server stores the obtained identification information of the consumable component and the device in the server-side storage unit. When the user of the device corresponding to the obtained device identification information subsequently enrolls in the reward granting service, the server stores, in the server-side storage unit, pre-enrollment reward information indicating rewards that are grantable in accordance with the consumable component corresponding to the obtained identification information, as a consumable component that was collected for recycling prior to enrollment.

### BRIEF DESCRIPTION OF DRAWINGS

FIG. 1 is a block diagram illustrating a functional configuration of a system.

FIG. 2A schematically illustrates an enrolled user database.

FIG. 2B schematically illustrates a non-enrolled user database.

FIG. 2C schematically illustrates a collection database.

FIGS. 3A and 3B illustrate images displayed on a touch panel of a printer.

FIG. 4A is a flowchart illustrating a process related to transmission of a cartridge list from the printer. FIG. 4B is a flowchart illustrating a process related to granting recycle points by a server for a point reward service.

FIG. 5 is a sequence diagram illustrating a sequence of actions performed by a printer, a server, and an external terminal when a user enrolls in a point reward service.

FIG. 6 is a sequence diagram illustrating a sequence of actions performed by a printer, a server, and an external terminal when a user enrolls in a point reward service, according to a modified example of the first embodiment.

FIG. 7A is a flowchart illustrating a process related to writing a printer ID into cartridge memory by a printer.

FIG. 7B is a flowchart illustrating a process related to granting recycle points by a server.

FIG. 8 is a sequence diagram illustrating a sequence of actions performed by a printer, a server, and an external terminal when a user enrolls in a point reward service.

FIG. 9 is a sequence diagram illustrating another sequence of actions performed by a printer, a server, and an external terminal when a user enrolls in a point reward service.

### DESCRIPTION

### First Embodiment

### System Overview

Hereinafter, a consumable component management system 1 according to a first embodiment will be described.

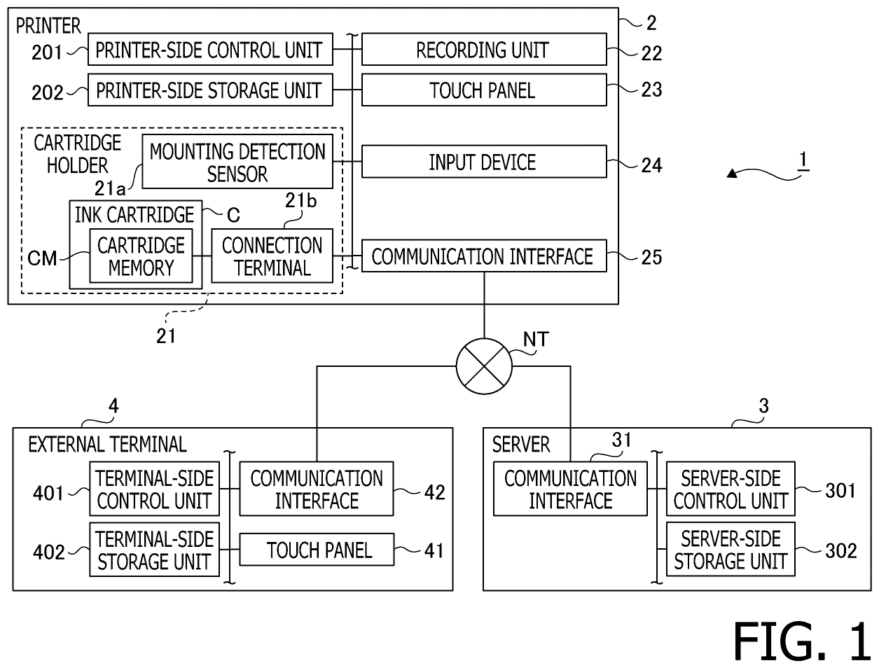

As illustrated in FIG. 1, a consumable component management system 1 includes a printer 2, a server 3, and an external terminal 4. The printer 2, the server 3, and the external terminal 4 are communicatively connected to each other via a network NT, such as the Internet. Note that the printer 2 and the external terminal 4 may be communicatively connected via a wired connection such as a USB cable, or via wireless communication such as Wi-Fi® (registered trademark of Wi-Fi Alliance), or short-range wireless communication such as Bluetooth® (registered trademark of Bluetooth SIG, Inc.). Further, the printer 2 and the external terminal 4 may also be connected to each other via the server 3.

It should be understood that, throughout this specification and the claims, the terms “unit” and “section” are intended to refer to hardware-based components, assemblies, or structural elements, unless expressly indicated otherwise. In this context, “unit” may refer to a discrete hardware component or device comprising one or more physical elements, and “section” may refer to a defined portion of such a structure or component.

### Printer Overview

The printer 2, corresponding to a “consumable component consuming device” according to aspects of the present disclosure, is an inkjet printer configured to record (print) images on a recording medium using ink, and includes a cartridge holder 21, a recording unit 22, a touch panel 23, an input device 24, a communication interface 25, a printer-side control unit 201, a printer-side storage unit 202, and the like.

The cartridge holder 21, corresponding to a “mounting portion” according to aspects of the present disclosure, detachably holds an ink cartridge C, which correspond to “consumable component” according to aspects of the present disclosure. It should be noted that only one ink cartridge C is shown in FIG. 1, the printer 2 may be configured to mount multiple ink cartridges C as described below. Each of the ink cartridges C includes a cartridge housing (not shown) configured to store ink, and a cartridge memory CM corresponding to a “consumable component memory” according to aspects of the present disclosure. The cartridge memory CM is a nonvolatile memory, and is configured to store various types of information including cartridge identification information (referred to below as “cartridge ID”), which corresponds to “consumable component identification information” according to aspects of the present disclosure and uniquely identifies the ink cartridge C.

In more detail, the multiple ink cartridges C include an ink cartridge C that stores yellow ink, an ink cartridge C that stores magenta ink, an ink cartridge C that stores cyan ink, and an ink cartridge C that stores black ink. However, for the sake of description, these cartridges are collectively referred to simply as “ink cartridge C” without distinguishing among them in the following description.

The recording unit 22 is an inkjet recording mechanism that is configured to consume inks stored in the ink cartridges C mounted on the cartridge holder 21 and to record an image on a recording medium, such as paper.

The touch panel 23, corresponding to a “display unit” and a “device display unit” according to aspects of the present disclosure, is configured to accept various user inputs and to display various setting screens, operational states, and the like to the user. The input device 24 is configured to receive user inputs. The communication interface 25 is a wired or wireless network interface configured to communicate with other devices and is connected to the network NT.

The printer-side control unit 201, corresponding to a “control unit” and a “device control unit” according to aspects of the present disclosure, is configured to control operations of various components of the printer 2 and to manage the operation of the printer 2. The printer-side control unit 201 includes a CPU (Central Processing Unit), a ROM (Read Only Memory) that stores programs to be executed by the CPU, a RAM (Random Access Memory) that temporarily stores data necessary for program execution, and the like. The printer-side control unit 201 is configured to perform various processes using the CPU in accordance with programs stored in the ROM.

A printer-side storage unit 202, corresponding to a “device-side storage unit” according to aspects of the present disclosure, is a nonvolatile memory or the like, and is configured to store unique identification information (“device identification information” according to aspects of the present disclosure, hereinafter referred to as “printer ID”) for identifying the printer 2, as well as various types of data, such as a cartridge list described later.

The cartridge holder 21 is provided with a mounting detection sensor 21a and connection terminals 21b. The mounting detection sensor 21a is a sensor that is configured to detect the mounting of the ink cartridge C onto the cartridge holder 21. The connection terminals 21b are terminals that are configured to be electrically connected to the cartridge memory CM of the ink cartridge C when the ink cartridge C is mounted in the cartridge holder 21. The printer-side control unit 201 is configured to perform reading from and writing to the cartridge memory CM of the ink cartridge C via the connection terminals 21b.

### Server Overview

The server 3 is a server installed and managed by a manufacturer or other provider, and includes a communication interface 31, a server-side control unit 301, a server-side storage unit 302, and the like. The communication interface 31 is a network interface similar to the communication interface 25.

The server-side control unit 301 is configured to control operations of various components of the server 3 and to manage the operation of the server 3, and includes a CPU, a ROM, a RAM, and the like. The server-side control unit 301 is configured to perform various processes by the CPU in accordance with programs stored in the ROM. The server-side storage unit 302 is a nonvolatile memory or the like, and is configured to store various types of data, including an enrolled user database, a non-enrolled user database, and a collection database, which will be described later.

### External Terminal Overview

The external terminal 4 is, in the present embodiment, a mobile terminal such as a smartphone owned by a user. However, the external terminal 4 is not limited thereto, and may be, for example, a personal computer or the like.

The external terminal 4 includes a touch panel 41, a communication interface 42, a terminal-side control unit 401, a terminal-side storage unit 402, and the like. The touch panel 41, corresponding to a “terminal display unit” according to aspects of the present disclosure, has similar functions to the touch panel 23. The communication interface 42 is a network interface similar to the communication interface 25.

The terminal-side control unit 401 is configured to control operations of various components of the external terminal 4 and to manage the operation of the external terminal 4, and includes a CPU, a ROM, a RAM, and the like. The terminal-side control unit 401 is configured to perform various processes by the CPU in accordance with programs stored in the ROM. The terminal-side storage unit 402 is a nonvolatile memory or the like, and is configured to store various types of information, including the printer ID of the printer 2 owned by the user.

When an ink cartridge C mounted in the cartridge holder 21 is used for recording on paper by the recording unit 22, ink inside the ink cartridge C is consumed. Therefore, when the ink in the ink cartridge C is consumed and runs out, it becomes necessary for the user to replace the ink cartridge C mounted in the cartridge holder 21.

In recent years, from the perspectives of environmental protection and ecology, it has been increasingly desirable to recycle consumable components such as the ink cartridge C described above. The term “recycling” as used herein includes the concept of reusing used consumable components as materials or raw resources, as well as remanufacturing such components.

For example, recycling of the ink cartridge C may be performed as follows. That is, when the ink in the ink cartridge C is fully consumed and the cartridge becomes empty, the user has the ink cartridge C collected by a recycling service provider, for example, by mailing it. The recycling service provider performs a regeneration process on the collected ink cartridge C. For instance, the recycling service provider may refill the collected ink cartridge C with ink to produce a regenerated cartridge that can be used again. The regenerated ink cartridge C is then delivered to users through retailers or the like.

In order to promote recycling, the consumable component management system 1 of the present embodiment provides users with a point reward service, corresponding to a “reward granting service” according to aspects of the present disclosure, in which recycling points are granted for each ink cartridge C collected for recycling. In this point reward service, when a user who has enrolled in the service has ink cartridges C collected for recycling, recycling points are granted to the user based on collected cartridge information (described later) associated with the collected ink cartridges C. The recycling points are points that can be returned to the user's benefit in some form, and may be used, for example, for the purchase of an ink cartridge C.

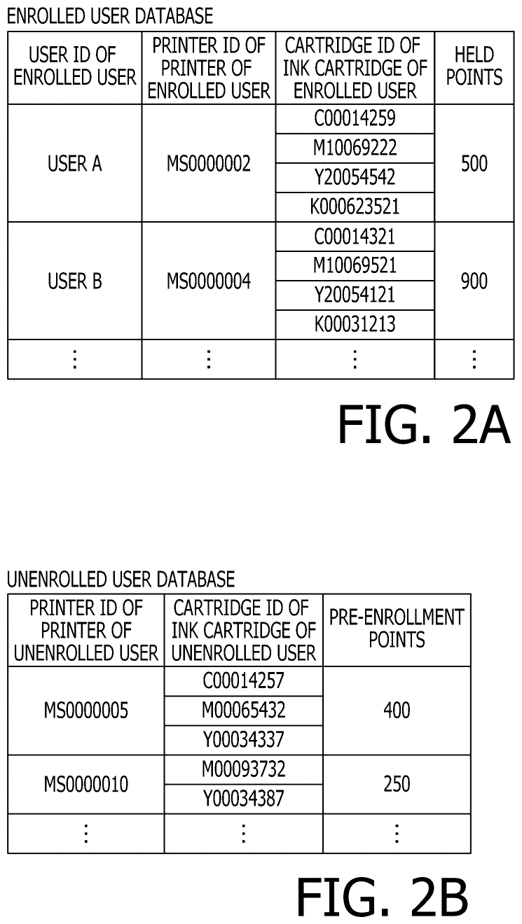

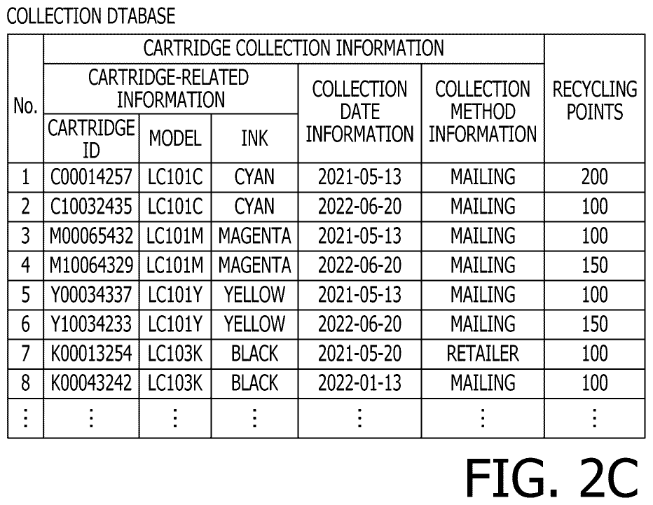

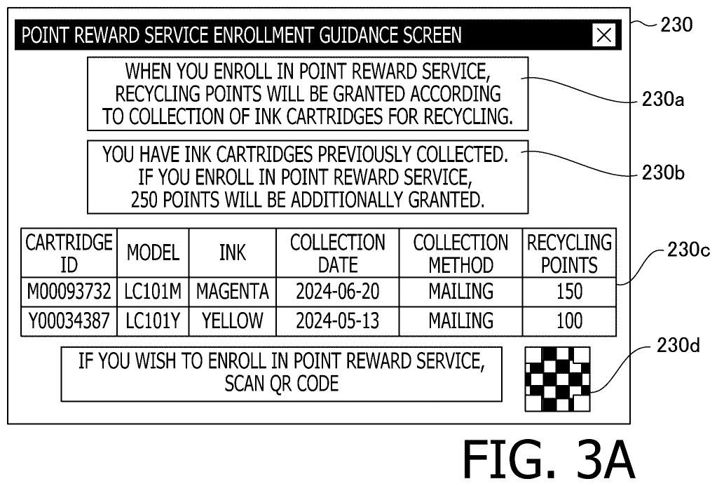

The server-side storage unit 302 of the server 3 stores an enrolled user database for each user who has enrolled in the point reward service. As illustrated in FIG. 2A, the enrolled user database stores, in an associated manner, a user ID for identifying the enrolled user, a printer ID of a printer 2 owned by the user, a cartridge ID for each ink cartridge C used in the printer 2, and held points, which represent the total amount of recycling points currently held by the user.

When an ink cartridge C is collected, a recycling service provider inputs collected cartridge information into the server 3. The collected cartridge information includes cartridge-related information, collection date information, collection method information, and the like, concerning the collected ink cartridge C. The cartridge-related information includes a cartridge ID, a product model number, a type such as the color of ink stored in the cartridge, and a condition of the ink cartridge C. The collection date information indicates the date on which the ink cartridge C was collected. The collection method information indicates a method by which the ink cartridge C was collected, for example, whether it was collected by mailing or through a retailer.

In one example, the recycling service provider operates a network-connected terminal or workstation configured with a client application or web interface enabling the recycling service provider to input the cartridge collection data, which is then transmitted over the internet to the server 3. In such a case, the server 3 obtains the cartridge collection information from the recycling service provider through the communication interface 31.

The server-side control unit 301 of the server 3 calculates recycling points for each collected ink cartridge C, based on collected cartridge information input into the server 3 by a recycling service provider in association with the collected ink cartridge C. The server-side control unit 301 may calculate the recycling points such that the same number of points is granted for each ink cartridge C, regardless of the type or condition of the collected ink cartridge C, or may calculate the recycling points such that different numbers of points are granted depending on the type or condition of the collected ink cartridge C. For example, a greater number of recycling points may be granted when the collected ink cartridge C is in a better condition. Additionally, a greater number of recycling points may be granted when the ink cartridge C has been collected more times for recycling.

When a cartridge ID included in the collected cartridge information matches a cartridge ID registered in the enrolled user database, the server-side control unit 301 determines that the ink cartridge C indicated by the cartridge ID is an ink cartridge C collected from the enrolled user identified by the user ID associated with the cartridge ID. The server-side control unit 301 then adds the calculated recycling points to the held points in association with the cartridge ID in the enrolled user database. In this manner, recycling points corresponding to the collection of the ink cartridge C are granted to the enrolled user. When the enrolled user uses the recycling points, the server-side control unit 301 subtracts the amount of used recycling points from the held points in association with the user ID of the enrolled user in the enrolled user database.

As recycling points are granted to users when the ink cartridges C are collected for recycling, users' awareness and motivation toward recycling can be further enhanced.

A user may not always have an ink cartridge C collected for recycling only after enrolling in the point reward service. In some cases, a user may have an ink cartridge C collected without enrolling in the point reward service, without knowing that recycling points would be granted in accordance with the collection for recycling upon enrollment. Therefore, if recycling points are not granted to a user for an ink cartridge C that was collected before the user enrolled in the point reward service, there could be a case where the user may feel dissatisfied.

Therefore, in the consumable component management system 1 of the present embodiment, it is possible to additionally grant recycling points to an enrolled user in accordance with ink cartridges C that were collected before the user enrolled in the point reward service. Specific details will be described below.

The server-side storage unit 302 is configured to store an unenrolled user database (see FIG. 2B) and a collection database (see FIG. 2C).

As illustrated in FIG. 2B, the unenrolled user database is a database relating to users who have not enrolled in the point reward service. The unenrolled user database stores a printer ID of a printer 2 owned by an unenrolled user, a cartridge ID of each ink cartridge C used in the printer 2, and pre-enrollment points (corresponding to “pre-enrollment reward information”) indicating the total recycling points that will be additionally granted when the unenrolled user enrolls in the point reward service, in an associated manner.

As illustrated in FIG. 2C, the collection database is a database relating to ink cartridges C that have been collected from unenrolled users. When a cartridge ID included in the collected cartridge information obtained from a recycling service provider is not registered in the enrolled user database, the server-side control unit 301 registers the collected cartridge information and the calculated recycling points in association with each other in the collection database. Accordingly, cartridge IDs of ink cartridges C collected from unenrolled users are stored in the collection database.

When an ink cartridge C is mounted in the cartridge holder 21, the printer-side control unit 201 of the printer 2 reads a cartridge ID stored in the cartridge memory CM of the mounted ink cartridge C and registers the cartridge ID in a cartridge list stored in the printer-side storage unit 202. The cartridge list is a list indicating the cartridge ID of each ink cartridge C that has previously been mounted in the cartridge holder 21.

After the printer 2 and the server 3 are communicatively connected, the server-side control unit 301 obtains a printer ID and a cartridge list stored in the printer-side storage unit 202 from the printer 2. If the obtained printer ID is already registered in the enrolled user database, the server-side control unit 301 registers the cartridge IDs in the obtained cartridge list in the enrolled user database in association with the registered printer ID. On the other hand, if the obtained printer ID is not registered in the enrolled user database, the server-side control unit 301 registers the cartridge IDs in the obtained cartridge list in the unenrolled user database in association with the obtained printer ID.

Further, when a cartridge ID (corresponding to “first unique identification information”) in the obtained cartridge list matches a cartridge ID (corresponding to “second unique identification information”) included in any of the collected cartridge information in the collection database, the server-side control unit 301 determines that the ink cartridge C indicated by the matching cartridge ID is an ink cartridge C that has previously been collected for recycling from an unenrolled user who owns the printer 2 (i.e., the source of the cartridge list) indicated by the obtained printer ID. The server-side control unit 301 calculates a total value of recycling points associated with the matching cartridge ID in the collection database. Then, the server-side control unit 301 registers the calculated total value of recycling points as pre-enrollment points in the unenrolled user database in association with the printer ID of the unenrolled user's printer 2.

With the above configuration, pre-enrollment points—which represent recycling points that can be granted in accordance with ink cartridges C collected before the user enrolls in the point reward service—can be accurately stored in the server-side storage unit 302.

Even if the system is configured to grant the above-described pre-enrollment points to the user upon enrollment in the point reward service, the user may still feel dissatisfied about the ink cartridges C collected before enrollment if the user is unaware of the pre-enrollment points.

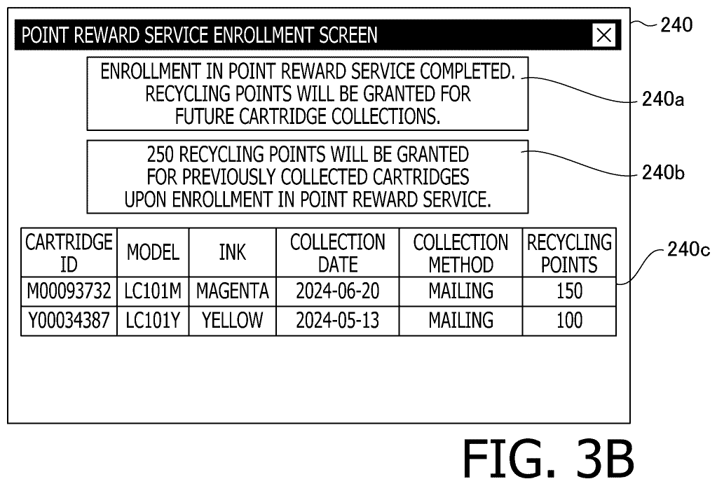

Therefore, after the unenrolled user's printer 2 and the server 3 are communicatively connected, the printer-side control unit 201 of the printer 2 obtains, from the server 3, pre-enrollment points associated with the printer ID of the printer 2 and collected cartridge information associated with the cartridge IDs in the cartridge list transmitted from the printer 2. Before the user enrolls in the point reward service, the printer-side control unit 201 causes the touch panel 23 to display an enrollment guidance screen 230, as illustrated in FIG. 3A, based on the obtained information. The enrollment guidance screen 230 includes guidance information 230a, pre-enrollment point information 230b, collected cartridge information 230c, and a QR code 230d (registered trademark of DENSO WAVE INCORPORATED).

The guidance information 230a is information for encouraging the user to enroll in the point reward service. The pre-enrollment point information 230b indicates the pre-enrollment points that will be additionally granted when the user enrolls in the point reward service. The collected cartridge information 230c is information obtained from the server 3 and includes cartridge-related information (corresponding to “consumable component information”), collection date information, collection method information, and the like. The QR code 230d is a QR code indicating a URL for user registration in the point reward service.

As described above, by causing the touch panel 23 to display the enrollment guidance screen 230 on the touch panel 23, the user can recognize that, upon enrolling in the point reward service, additional recycling points will be granted in accordance with ink cartridges C that were collected before enrollment. This makes it possible to reduce the likelihood that the user will feel dissatisfied about ink cartridges C collected before enrollment.

After the user enrolls in the point reward service, the server-side control unit 301 updates the databases stored in the server-side storage unit 302. For example, the server-side control unit 301 registers, in the enrolled user database, the user ID of the user who has enrolled in the point reward service, the printer ID of the printer 2 owned by the user, and the cartridge IDs associated with the printer ID in the unenrolled user database. In addition, the server-side control unit 301 registers, in the enrolled user database, the pre-enrollment points associated with the printer ID in the unenrolled user database as held points, in association with the printer ID of the user's printer 2.

The server-side control unit 301 also deletes, from the unenrolled user database, the cartridge IDs and held points associated with the printer ID of the printer 2 owned by the user who has enrolled in the point reward service. In addition, the server-side control unit 301 deletes, from the collection database, the collected cartridge information and recycling points associated with the cartridge IDs of the user's ink cartridges C.

After the user has enrolled in the point reward service, the printer-side control unit 201 causes the touch panel 23 to display an enrollment completion screen 240, as illustrated in FIG. 3B. The enrollment completion screen 240 includes enrollment completion information 240a, pre-enrollment point information 240b, and collected cartridge information 240c.

The enrollment completion information 240a is information for notifying the user that enrollment in the point reward service has been completed. The pre-enrollment point information 240b indicates the pre-enrollment points that are additionally granted to the user who has enrolled in the point reward service. The collected cartridge information 240c is the same as the collected cartridge information 230c included in the enrollment guidance screen 230.

As described above, after the user has enrolled in the point reward service, the user can recognize, through the display of the enrollment completion screen 240 on the touch panel 23, that additional recycling points have been granted in accordance with ink cartridges C collected before enrollment in the point reward service.

Process Related to Transmission of Cartridge List from Printer

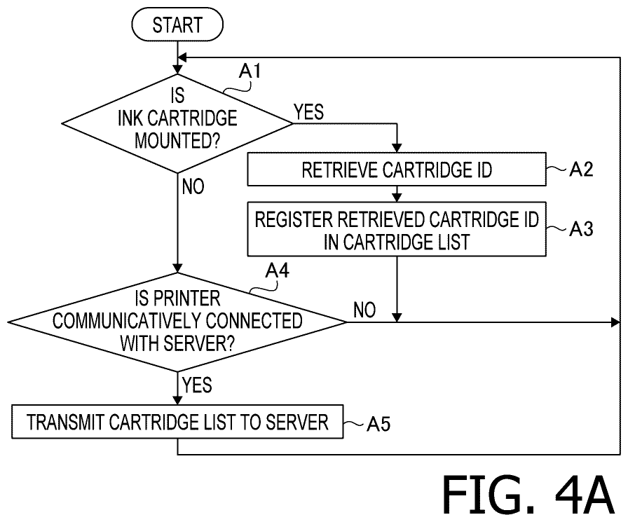

Next, the flow of processing related to transmission of the cartridge list from the printer 2 will be described with reference to FIG. 4A.

The printer-side control unit 201 judges, based on a signal from the mounting detection sensor 21a, whether an ink cartridge C has been newly mounted in the cartridge holder 21 (i.e., whether the state has transitioned from a state in which no ink cartridge C is mounted in the cartridge holder 21 to a state in which it is mounted) (A1). If it is determined that an ink cartridge C has been newly mounted (A1: YES), the printer-side control unit 201 reads, via the connection terminal 21b, the cartridge ID stored in the cartridge memory CM of the mounted ink cartridge C (A2).

Next, the printer-side control unit 201 registers the read cartridge ID in the cartridge list in the printer-side storage unit 202 (A3). After the processing of A3 is completed, the flow returns to A1.

If it is determined that an ink cartridge C has not been newly mounted (A1: NO), the printer-side control unit 201 judges whether the printer 2 is communicatively connected to the server 3 (A4). If it is determined that the printer 2 is not communicatively connected to the server 3 (A4: NO), the flow returns to A1.

On the other hand, if it is determined that the printer 2 is communicatively connected to the server 3 (A4: YES), the printer-side control unit 201 transmits the cartridge list stored in the printer-side storage unit 202 and its own printer ID to the server 3 (A5). Note that if the cartridge list stored in the printer-side storage unit 202 has not been updated since the last transmission, the processing of A5 may be omitted. After the processing of A5 is completed, the flow returns to A1.

### Process Related to Granting of Recycling Points by Server

Next, the flow of processing related to granting of recycling points by the server 3 will be described with reference to FIG. 4B.

The server-side control unit 301 judges whether collected cartridge information has been obtained from the recycling service provider (B1). If it is determined that collected cartridge information has been obtained (B1: YES), the server-side control unit 301 calculates recycling points based on the obtained collected cartridge information (B2).

Next, the server-side control unit 301 refers to the enrolled user database stored in the server-side storage unit 302 and judges whether a cartridge ID included in the collected cartridge information is associated with a printer ID of a printer 2 belonging to an enrolled user (B3). If it is determined that the cartridge ID is associated with the printer ID of the enrolled user's printer 2 (B3: YES), the server-side control unit 301 adds the recycling points calculated in B2 to the held points associated with the printer ID in the enrolled user database in the server-side storage unit 302 (B4), and then the flow returns to B1.

If it is determined that the cartridge ID is not associated with the printer ID of the enrolled user's printer 2 (B3: NO), the server-side control unit 301 associates the recycling points calculated in B2 with the obtained collected cartridge information and registers the associated information in the collection database stored in the server-side storage unit 302 (B5). The flow then returns to B1.

If it is determined that collected cartridge information has not been obtained (B1: NO), the server-side control unit 301 judges whether the server 3 is communicatively connected to the printer 2 (B6). If it is determined that the server 3 is not communicatively connected to the printer 2 (B6: NO), the flow returns to B1.

If it is determined that the server 3 is communicatively connected to the printer 2 (B6: YES), the server-side control unit 301 receives, from the printer 2, a cartridge list and a printer ID (B7). The server-side control unit 301 then registers the cartridge IDs in the received cartridge list in either the enrolled user database or the unenrolled user database (B8). Specifically, if the received printer ID is registered in the enrolled user database, the server-side control unit 301 registers the cartridge IDs in the received cartridge list in association with the received printer ID in the enrolled user database. On the other hand, if the received printer ID is not registered in the enrolled user database, the server-side control unit 301 registers the cartridge IDs in the received cartridge list in association with the received printer ID in the unenrolled user database.

The server-side control unit 301 then compares each cartridge ID in the received cartridge list with each cartridge ID stored in the collection database in the server-side storage unit 302 (B9). If it is determined that none of the cartridge IDs in the cartridge list match any of the cartridge IDs in the collection database (B10: NO), the flow returns to B1.

If it is determined that at least one of the cartridge IDs in the cartridge list matches any of the cartridge IDs in the collection database (B10: YES), the server-side control unit 301 updates the unenrolled user database stored in the server-side storage unit 302 (B11). Specifically, the server-side control unit 301 adds recycling points to the pre-enrollment points associated with the printer ID received in B7 in the unenrolled user database. The recycling points to be added are the total of the recycling points associated with the cartridge IDs in the collection database that match the cartridge IDs in the received cartridge list. After the processing of B11 is completed, the flow returns to B1.

### Sequence When User Enrolls in Point Reward Service

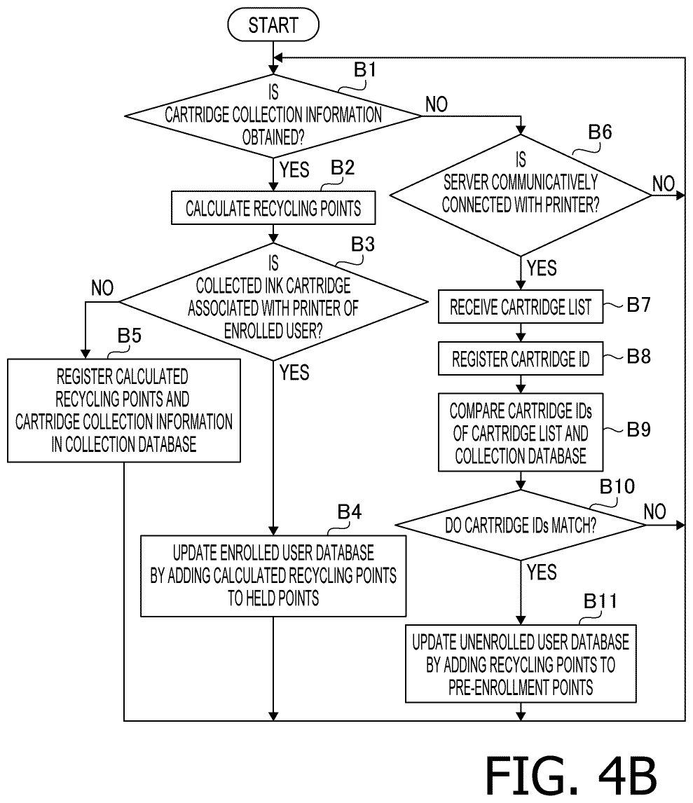

Next, a sequence of interactions among the printer 2, the server 3, and the external terminal 4, performed when a user who has not yet enrolled in the point reward service enrolls in the service, will be described with reference to FIG. 5. It is assumed that, at the start of the sequence shown in FIG. 5, the printer 2, the server 3, and the external terminal 4 are communicatively connected to one another.

First, when the printer-side control unit 201 of the printer 2 receives, via the touch panel 23, a request from the user to display registration guidance for the point reward service (C1), it transmits a request to the server 3 to issue a registration URL (C2). Next, upon receiving the request, the server-side control unit 301 transmits the registration URL to the printer 2 (C3). Thereafter, the printer-side control unit 201 generates a QR code from the received registration URL (C4).

Next, the printer-side control unit 201 transmits the cartridge list stored in the printer-side storage unit 202 and the printer ID to the server 3 (C5). Thereafter, the server-side control unit 301 updates the unenrolled user database stored in the server-side storage unit 302 based on the received cartridge list (C6) by performing, for example, processing similar to the processing in B7 through B11 described with reference to FIG. 3B. This allows the unenrolled user database to be brought into a state that reflects the latest cartridge list stored in the printer-side storage unit 202 of the user's printer 2.

Next, the server-side control unit 301 extracts, from the unenrolled user database in the server-side storage unit 302, the collected cartridge information and the pre-enrollment points associated with the printer ID of the user's printer 2, and transmits the extracted information to the printer 2 (C7). Thereafter, based on the received information and the QR code generated in the processing of C4, the printer-side control unit 201 causes the touch panel 23 to display the enrollment guidance screen 230 shown in FIG. 3A (C8).

Next, when reading the QR code displayed on the touch panel 23 of the printer 2 based on a user operation input via the touch panel 41 (C9), the terminal-side control unit 401 of the external terminal 4 transmits a request to the server 3 to obtain page information, based on the registration URL indicated by the read QR code (C10). Thereafter, the server-side control unit 301 generates page information for user registration in the point reward service (C11), and transmits the generated page information to the external terminal 4 (C12).

Subsequently, the terminal-side control unit 401 generates a guidance screen based on the received page information to prompt the user to input user information required for user registration in the point reward service, and causes the touch panel 41 to display the guidance screen (C13). If user information is not entered (C14: NO), the terminal-side control unit 401 determines that the user does not register for the point reward service, and ends the process.

If user information is entered (C14: YES), the terminal-side control unit 401 transmits the entered user information to the server 3 (C15). Thereafter, the server-side control unit 301 performs a registration process for user enrollment in the point reward service based on the received user information (C16). At this time, the server-side control unit 301 updates the unenrolled user database, the enrolled user database, and the collection database stored in the server-side storage unit 302.

Specifically, the server-side control unit 301 registers the user ID of the enrolled user in the enrolled user database. The server-side control unit 301 also transfers the printer ID of the user's printer 2 and the cartridge IDs associated with the printer ID from the unenrolled user database to the enrolled user database. Furthermore, the server-side control unit 301 adds the pre-enrollment points associated with the printer ID in the unenrolled user database to the held points associated with the same printer ID in the enrolled user database. The server-side control unit 301 then deletes various types of data associated with the printer ID and the cartridge IDs of the user's ink cartridges C from the unenrolled user database and the collection database.

Thereafter, the server-side control unit 301 transmits registration completion information to the printer 2, indicating that user registration in the point reward service has been completed (C17). The printer-side control unit 201 then causes the touch panel 23 to display the enrollment completion screen 240 shown in FIG. 3B. After the processing of C17 is completed, this sequence is ended.

According to the first embodiment, before the user enrolls in the point reward service, the enrollment guidance screen 230 including the pre-enrollment point information 230b is displayed on the touch panel 23 of the printer 2 (see FIG. 3A). This enables the user to recognize that, upon enrolling in the point reward service, recycling points corresponding to the ink cartridges C collected prior to enrollment will be additionally granted. As a result, it is possible to reduce the likelihood that the user feels dissatisfied with respect to the ink cartridges C collected before enrollment in the point reward service. Further, since the enrollment guidance screen 230 includes the guidance information 230a that encourages the user to enroll in the point reward service, the user's motivation to enroll in the point reward service can be further enhanced.

Further, the enrollment guidance screen 230 includes collected cartridge information 230c. The collected cartridge information 230c includes cartridge-related information, collection date information, collection method information, and the like, regarding the ink cartridges C that have been collected. The cartridge-related information includes, for each collected ink cartridge C, a cartridge ID, a product model number, and a type such as the color of the ink stored in the cartridge. This enables the user to confirm that recycling points have been accurately granted for each ink cartridge C collected prior to enrollment in the point reward service.

Additionally, after the user has enrolled in the point reward service, the enrollment completion screen 240 including the pre-enrollment point information 240b is displayed on the touch panel 23 of the printer 2 (see FIG. 3B). This enables the user to recognize that recycling points corresponding to the ink cartridges C collected prior to enrollment have been additionally granted.

If recycling points corresponding to the ink cartridges C collected prior to enrollment in the point reward service are not accurately granted to the user, the user may feel dissatisfied. However, in the present embodiment, the server-side storage unit 302 stores a collection database and an unenrolled user database. That is, the cartridge collection information and the pre-enrollment points related to the ink cartridges C collected by the unenrolled user are stored in the server-side storage unit 302. This makes it possible to accurately grant the recycling points corresponding to the ink cartridges C collected by the user prior to enrollment when the user enrolls in the point reward service. As a result, it is possible to reduce the likelihood that the user may feel dissatisfied with respect to the ink cartridges C collected prior to enrollment in the point reward service.

While aspects of the present disclosure have been described in conjunction with example structures illustrated in the figures, various alternatives, modifications, variations, improvements, and/or substantial equivalents—whether currently known or later developed—may become apparent to those skilled in the art. Accordingly, the embodiments described above are intended to be illustrative, and not limiting. Various changes may be made without departing from the spirit and scope of the present disclosure as set forth in the claims. Some specific examples of potential modifications will be described below. In the following description, components identical to those in the first embodiment will not be redundantly described.

### Modification of the First Embodiment

A modification of the first embodiment is described below. In the embodiment described above, the enrollment guidance screen 230 including the pre-enrollment point information 230b and the enrollment completion screen 240 including the pre-enrollment point information 240b are displayed on the touch panel 23 of the printer 2. In this modification, however, those screens are displayed on the touch panel 41 of the external terminal 4.

### Sequence When User Enrolls in Point Reward Service

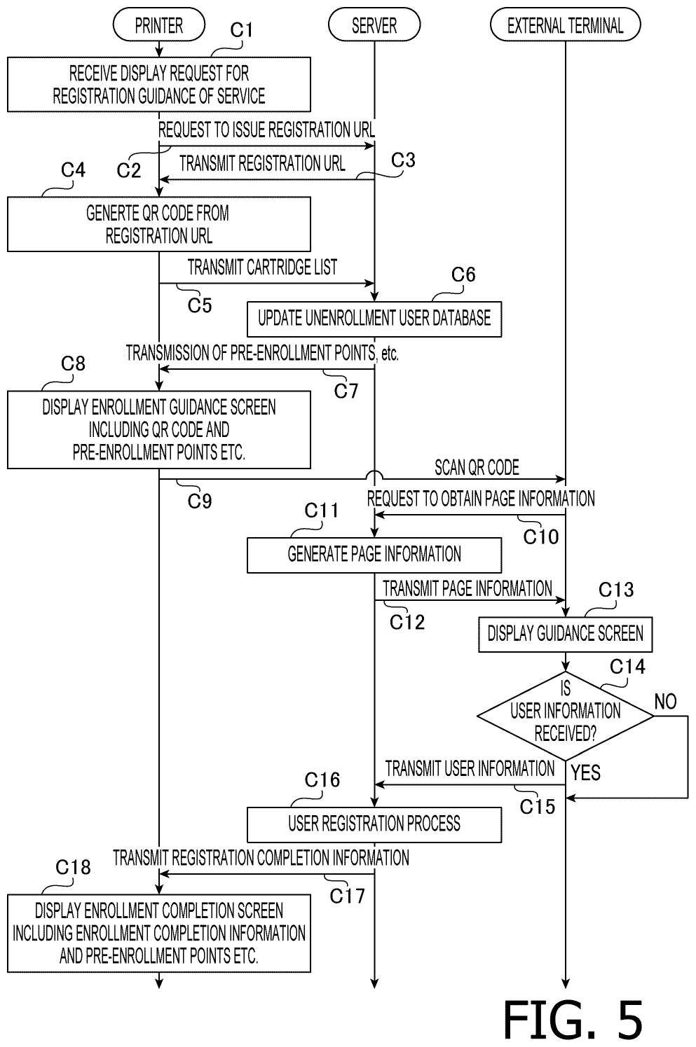

A sequence of operations performed by the printer 2, the server 3, and the external terminal 4 when the user enrolls in the point reward service according to this modification will be described below with reference to FIG. 6.

First, the printer-side control unit 201 of the user's printer 2 and the server-side control unit 301 execute processes DI to D3, which are similar to the processes C1 to C3 described above with reference to FIG. 5. Thereafter, the printer-side control unit 201 generates a QR code from the received registration URL and causes the touch panel 23 to display the generated QR code (D4).

Next, when reading the QR code displayed on the touch panel 23 of the printer 2 based on a user operation input via the touch panel 41 (D5), the terminal-side control unit 401 transmits a request to the server 3 to obtain page information, based on the registration URL indicated by the read QR code (D6).

Next, the server-side control unit 301 transmits a cartridge list transmission instruction to the printer 2 to instruct transmission of the cartridge list stored in the printer-side storage unit 202 of the printer 2 (D7). In response to receipt of the cartridge list transmission instruction, the printer-side control unit 201 transmits the cartridge list stored in the printer-side storage unit 202 and the printer ID to the server 3 (D8). Subsequently, the server-side control unit 301 updates the unenrolled user database stored in the server-side storage unit 302 based on the received cartridge list, in the same manner as in the processing of C6 (D9).

Next, the server-side control unit 301 generates page information for user registration in the point reward service (D10). This page information includes the cartridge collection information and the pre-enrollment points associated with the printer ID of the user's printer 2, which are extracted from the unenrolled user database stored in the server-side storage unit 302.

The server-side control unit 301 transmits the generated page information to the external terminal 4 (D11). In response to receipt of the page information, the terminal-side control unit 401 generates an enrollment guidance screen based on the received page information and causes the touch panel 41 to display the screen (D12). This enrollment guidance screen includes information such as guidance information, pre-enrollment point information, and collected cartridge information, similar to the enrollment guidance screen 230 shown in FIG. 3A.

Thereafter, the printer-side control unit 201 and the server-side control unit 301 execute processes D13 to D15, which are similar to the processes C14 to C16 described above.

Next, the server-side control unit 301 transmits registration completion information to the external terminal 4 (D16). The terminal-side control unit 401 then causes the touch panel 41 to display an enrollment completion screen similar to the enrollment completion screen 240 shown in FIG. 3B (D17). Upon completion of the processing in D17, this sequence is terminated.

As described above, in this modification, the enrollment guidance screen including pre-enrollment point information and the enrollment completion screen including pre-enrollment point information are displayed on the touch panel 41 of the external terminal 4. This enables the user to recognize, as in the first embodiment, that recycling points corresponding to the ink cartridges C collected prior to enrollment are additionally granted. As a result, it is possible to reduce the likelihood that the user may feel dissatisfied with respect to the ink cartridges C collected prior to enrollment in the point reward service.

### Second Embodiment

A second embodiment will now be described. Unlike the first embodiment described above, in the second embodiment, the printer-side control unit 201 does not transmit the cartridge list to the server 3. Instead, the printer-side control unit 201 writes the printer ID of the printer 2 into the cartridge memory CM of the ink cartridge C mounted in the cartridge holder 21. Accordingly, the cartridge memory CM of the ink cartridge C collected by the user for recycling stores not only the cartridge ID but also the printer ID of the printer 2.

The cartridge collection information input to the server 3 by the recycling service provider includes, in addition to the cartridge-related information, collection date information, and collection method information described above, the printer ID stored in the cartridge memory CM of the ink cartridge C. When the server-side control unit 301 obtains the cartridge collection information and determines that the printer ID included in the cartridge collection information is not registered in the enrolled user database, the server-side control unit 301 registers the printer ID and the cartridge ID included in the cartridge collection information in the unenrolled user database. The server-side control unit 301 also adds the calculated recycling points to the pre-enrollment points in the unenrolled user database.

In the configuration of the present embodiment as well, recycling points corresponding to the ink cartridges C collected by the user prior to enrollment in the point reward service can be accurately stored as pre-enrollment points in the server-side storage unit 302.

Process of Writing Printer ID into Cartridge Memory

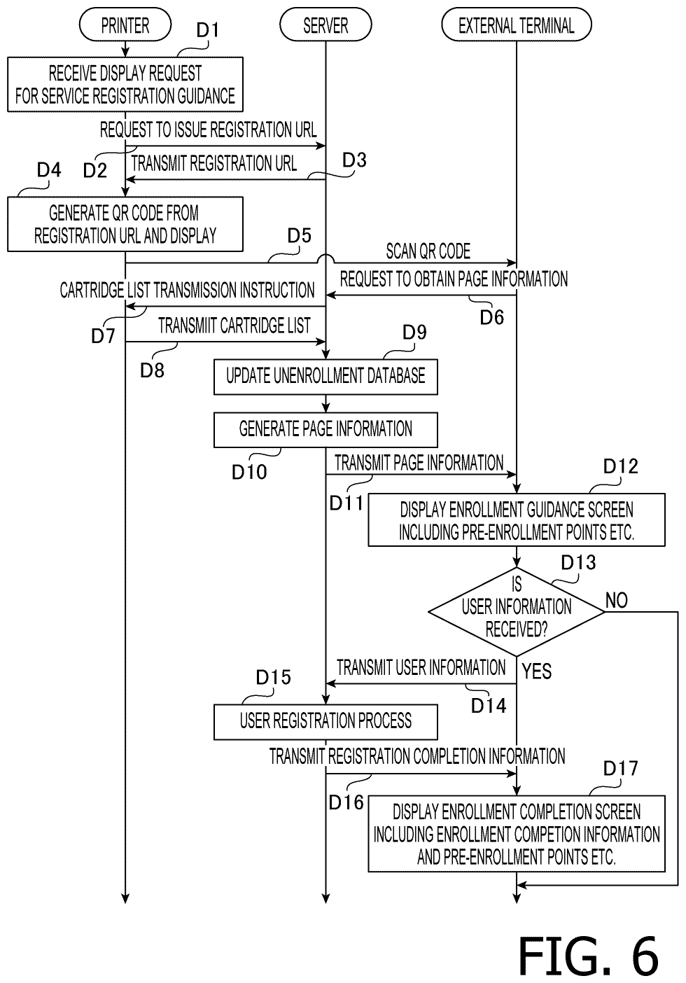

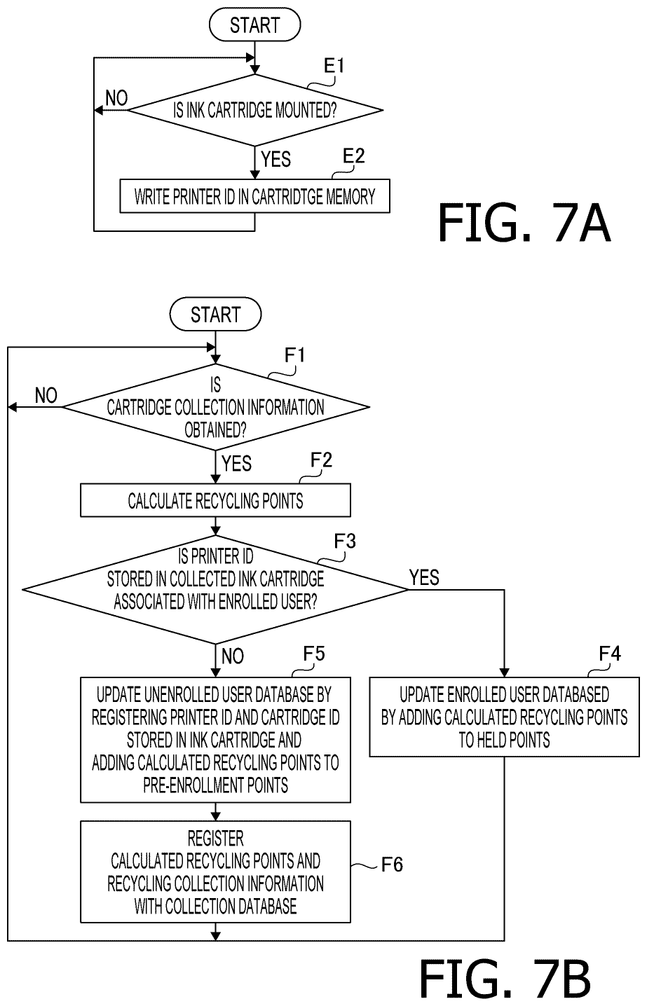

A process flow of the printer 2 related to writing the printer ID into the cartridge memory CM according to the second embodiment will be described below with reference to FIG. 7A.

The printer-side control unit 201 determines whether an ink cartridge C has been newly mounted in the cartridge holder 21, based on a signal from the mounting detection sensor 21a (E1). If it is determined that an ink cartridge C has not been newly mounted (E1: NO), the process returns to E1. If it is determined that an ink cartridge C has been newly mounted (E1: YES), the printer-side control unit 201 writes the printer ID, which is stored in the printer-side storage unit 202, into the cartridge memory CM of the mounted ink cartridge C via the connection terminals 21b (E2). After the processing in E2 is completed, the process returns to E1.

### Process of Granting Recycling Points by Server

A process flow related to the granting of recycling points by the server 3 will now be described with reference to FIG. 7B.

The server-side control unit 301 determines whether cartridge collection information has been obtained (F1). If not (F1: NO), the process returns to F1.

If it is determined that cartridge collection information has been obtained (F1: YES), the server-side control unit 301 calculates recycling points based on the obtained cartridge collection information (F2).

Next, the server-side control unit 301 determines whether the printer ID included in the cartridge collection information is registered in the enrolled user database stored in the server-side storage unit 302 (F3). If it is determined that the printer ID is registered in the enrolled user database (F3: YES), the server-side control unit 301 adds the recycling points calculated in the process F2 to the held points associated with the printer ID of the user's printer 2 in the enrolled user database (F4), and then the process returns to F1.

If it is determined that the printer ID is not registered in the enrolled user database (F3: NO), the server-side control unit 301 associates the cartridge ID and the printer ID included in the obtained cartridge collection information and registers them in the unenrolled user database stored in the server-side storage unit 302 (F5). The server-side control unit 301 also adds the recycling points calculated in the process F2 to the pre-enrollment points associated with the cartridge ID in the unenrolled user database.

Next, the server-side control unit 301 associates the obtained cartridge collection information with the recycling points calculated in the process F2 and registers them in the collection database stored in the server-side storage unit 302 (F6), and then the process returns to F1.

### Sequence When User Enrolls in Point Reward Service

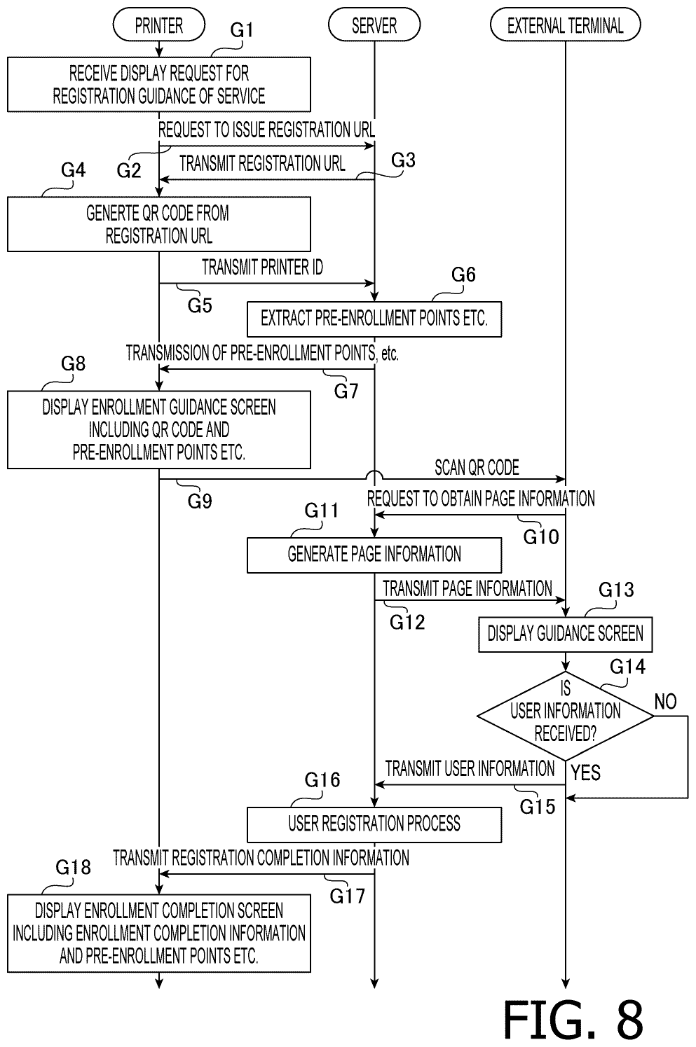

A sequence of operations performed by the printer 2, the server 3, and the external terminal 4 when the user enrolls in the point reward service will now be described with reference to FIG. 8. It is assumed that, at the beginning of the sequence shown in FIG. 8, the printer 2, the server 3, and the external terminal 4 are communicatively connected to one another.

First, the printer-side control unit 201 of the user's printer 2 and the server-side control unit 301 execute processes G1 to G4, which are similar to the processes C1 to C4 described above with reference to FIG. 5. Subsequently, the printer-side control unit 201 transmits its printer ID to the server 3 (G5). The server-side control unit 301 then extracts, from the collection database stored in the server-side storage unit 302, the cartridge collection information and recycling points associated with the received printer ID, and also extracts, from the unenrolled user database, the pre-enrollment points associated with the received printer ID (G6). The server-side control unit 301 then transmits the information extracted in the process G6 to the printer 2 (G7). Thereafter, the printer-side control unit 201 causes the enrollment guidance screen 230, as shown in FIG. 3A, to be displayed on the touch panel 23 based on the received information and the QR code generated in the process C4 (G8).

Thereafter, the printer-side control unit 201, the server-side control unit 301, and the terminal-side control unit 401 execute processes G9 to G18, which are similar to the processes C9 to C18 described above. The sequence is then terminated.

Also in the second embodiment, as in the first embodiment, the enrollment guidance screen 230 including the pre-enrollment point information 230b (see FIG. 3A) and the enrollment completion screen 240 including the pre-enrollment point information 240b are displayed on the touch panel 23 of the printer 2. This reduces the likelihood that the user may feel dissatisfied with respect to the ink cartridges C collected prior to enrollment in the point reward service.

In addition, cartridge collection information and pre-enrollment points related to the ink cartridges C collected by unenrolled users-users who have not enrolled in the point reward service-are stored in the server-side storage unit 302. This makes it possible to accurately grant to the user, upon enrollment, the recycling points corresponding to the ink cartridges C collected prior to enrollment in the point reward service. As a result, the likelihood that the user may feel dissatisfied with respect to the ink cartridges C collected prior to enrollment can be reduced.

### Modification of the Second Embodiment

A modification of the second embodiment will now be described. In this modification, as in the modification of the first embodiment, the enrollment guidance screen including pre-enrollment point information, and the enrollment completion screen including pre-enrollment point information are displayed on the touch panel 41 of the external terminal 4.

### Sequence When User Enrolls in Point Reward Service

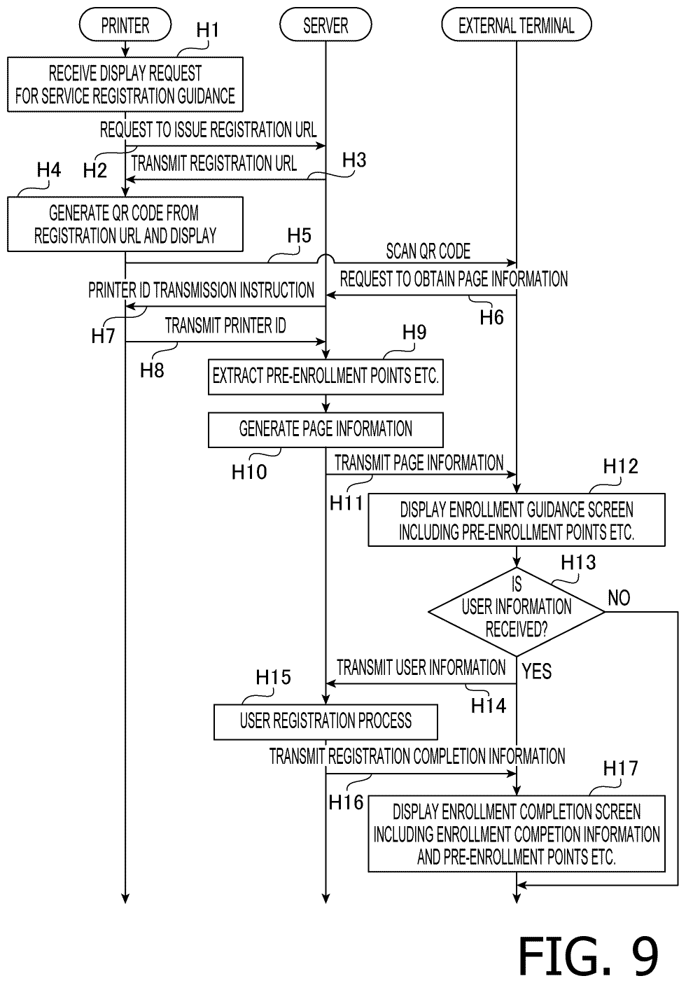

A sequence of operations performed by the printer 2, the server 3, and the external terminal 4 when the user enrolls in the point reward service according to this modification will now be described with reference to FIG. 9.

First, the printer-side control unit 201 of the user's printer 2, the server-side control unit 301, and the terminal-side control unit 401 execute processes H1 to H6, which are similar to the processes D1 to D6 described above with reference to FIG. 6. Thereafter, the server-side control unit 301 transmits a printer ID transmission instruction to the printer 2, instructing it to send its printer ID (H7). Next, the printer-side control unit 201 transmits its printer ID to the server 3 (H8). The server-side control unit 301 then retrieves, from the collection database stored in the server-side storage unit 302, the cartridge collection information and recycling points associated with the received printer ID, and also retrieves, from the unenrolled user database, the pre-enrollment points associated with the same printer ID (H9). Based on the retrieved information, the server-side control unit 301 generates page information (H10).

Thereafter, the printer-side control unit 201, the server-side control unit 301, and the terminal-side control unit 401 execute processes H11 to H17, which are similar to the processes D11 to D17 described above. The sequence is then terminated.

Also in this modification, the enrollment guidance screen including pre-enrollment point information and the enrollment completion screen including pre-enrollment point information are displayed on the touch panel 41 of the external terminal 4. This enables the user to recognize that recycling points corresponding to the ink cartridges C collected prior to enrollment in the point reward service are additionally granted, as in the second embodiment. As a result, the likelihood that the user may feel dissatisfied with respect to the ink cartridges C collected prior to enrollment can be reduced.

Further modifications will now be described below.

In the embodiments described above, the consumable component consuming device was an inkjet printer. However, the present disclosure is not limited to this configuration. For example, the consumable component consuming device may be a laser printer. In such a case, examples of consumable components include a toner cartridge that stores toner, a photoconductive drum, and the like. Consumable components may also include parts that require replacement due to deterioration, such as a cutter, a roller, or a waste liquid tank included in the printer.

Furthermore, the consumable component consuming device may be a device other than a printer. For example, the consumable component consuming device may be a scanner or a conveyance device that transports paper. In such cases, a conveyance roller that transports paper is an example of a consumable component. The consumable component consuming device may also be an electronic device such as a personal computer or a smartphone. In such cases, examples of consumable components include batteries and other components constituting the electronic device.

In the first and second embodiments described above, the reward granted to the user in accordance with the collection of ink cartridges C for recycling was in the form of recycling points. However, the present disclosure is not limited to this configuration. The reward may alternatively be any form of incentive that provides value to the user, such as a coupon that can be used when purchasing ink cartridges.

In the above-described embodiments, the pre-enrollment point information is displayed on the touch panel 23 of the printer 2 or the touch panel 41 of the external terminal 4 both before and after the user enrolls in the point reward service.

In the above-described embodiment, the regeneration of used ink cartridges is typically performed by recycling service providers. However, the present disclosure is not limited to such an arrangement. For example, an ink refilling apparatus capable of refilling ink cartridges may be installed at a retail store or similar facility, and a user may bring a used ink cartridge to the store for collection and have it refilled by the ink refilling apparatus, thereby enabling the regeneration of the ink cartridge. In this case, cartridge collection information is provided from the ink refilling apparatus to the server.

What is claimed is:

1. A consumable component consuming device, comprising:
a mounting unit configured to detachably mount a consumable component;
a display unit; and
a control unit,
wherein the control unit causes the display unit to display pre-enrollment reward information indicating rewards that are grantable in accordance with the consumable components collected prior to an enrollment of a user in a reward granting service to grant a reward based on collection of the consumable component for recycling.

2. The consumable component consuming device according to claim 1,
wherein the control unit is configured to cause the display unit to display the pre-enrolment reward information before the user enrolls in the reward granting service.

3. The consumable component consuming device according to claim 2,
wherein the control unit is configured to cause the display unit to display, before the user enrolls in the reward granting service, guidance information encouraging the user to enroll in the reward granting service together with the pre-enrollment reward information.

4. The consumable component consuming device according to claim 1,
wherein the control unit is configured to cause the display unit to display the pre-enrollment reward information after the user enrolls in the reward granting service.

5. The consumable component consuming device according to claim 1,
wherein the control unit is configured to cause the display unit to display, together with the pre-enrollment reward information, collection date information indicating dates when consumable components were collected for recycling before the user enrolled in the reward granting service.

6. The consumable component consuming device according to claim 1,
wherein the control unit is configured to cause the display unit to display, together with the pre-enrollment reward information, consumable component information related to one or both of a model number and a type of each of consumable components that were collected for recycling before the user enrolled in the reward granting service.

7. The consumable component consuming device according to claim 1,
wherein the control unit is configured to cause the display unit to display, together with the pre-enrollment reward information, collection method information indicating a method by which each consumable component was collected for recycling before the user enrolled in the reward granting service.

8. An external terminal connectable to a consumable component consuming device comprising a mounting unit configured to detachably mount a consumable component, the external terminal comprising:
a terminal-side display unit; and
a terminal-side control unit,
wherein the terminal-side control unit is configured to cause the terminal-side display unit to display pre-enrollment reward information indicating rewards that are grantable in accordance with consumable components collected prior to an enrollment of a user in a reward granting service to grant a reward based on collection of the consumable component for recycling.

9. A consumable component management system comprising a consumable component consuming device and a server,
the consumable component consuming device comprising:
a mounting unit configured to detachably mount the consumable component;
a device-side control unit; and
a device-side storage unit,
the server comprising:
a server-side control unit; and
a server-side storage unit,
wherein the device-side control unit is configured to store first unique identification information of the consumable component mounted on the mounding unit in the device-side storage unit,
wherein the server-side control unit is configured to:
when second unique identification information of the consumable component collected through recycling corresponds to unique identification information of the consumable component associated with the consumable component consuming device of a user who is enrolled in a reward granting service that grants a reward in accordance with collection of the consumable component for recycling, grant the reward to the user;
wherein when the second unique identification information does not correspond to unique identification information of the consumable component associated with the consumable component consuming device of the user, have the second unique identification information stored in the server-side storage;
wherein, after the consumable component consuming device and the server are communicatively connected, obtain the first unique identification information stored in the device-side storage unit from the consumable component consuming device; and
wherein, when the obtained first unique identification information matches the second unique identification information stored in the server-side storage unit, store, in the server-side storage unit, pre-enrollment reward information indicating rewards that are grantable in accordance with the consumable component corresponding to the first unique identification information, as a consumable component collected for recycling by the user of the consumable component consuming device when the user enrolls in the reward granting service.

10. The consumable component management system according to claim 9,
further comprising a device-side display unit,
wherein, when the user of the consumable component consuming device is not enrolled in the reward granting service, the device-side control unit is configured to:
after the consumable component consuming device and the server are communicatively connected;
obtain, from the server, the pre-enrollment reward information stored in the server-side storage unit; and
cause the device-side display unit to display the pre-enrollment reward information.

11. The consumable component management system according to claim 9,
further comprising an external terminal that includes:
a terminal-side control unit; and
a terminal-side display unit,
wherein, when the user of the consumable component consuming device is not enrolled in the reward granting service, the terminal-side control unit is configured to:
after the external terminal and the server are communicatively connected, obtain, from the server, the pre-enrollment reward information stored in the server-side storage unit; and
cause the terminal-side display unit to display the obtained pre-enrollment reward information.

12. A consumable component management system comprising a consumable component consuming device and a server,
the consumable component consuming device comprising:
a mounting unit configured to detachably mount a consumable component having a consumable component storage configured to store unique identification information of the consumable component; and
a device-side control unit,
the server comprising:
a server-side control unit; and
a server-side storage unit,
wherein the device-side control unit is configured to, when the consumable component is mounted on the mounting unit, store unique identification information of the consumable component consuming device in the consumable component storage of the mounted consumable component,
wherein the server-side control unit is configured to:
obtain, from the consumable component storage of a consumable component collected for recycling, the unique identification information of the consumable component and unique identification information of the device;
when the obtained unique identification information of the device corresponds to device identification information associated with a consumable component consuming device of a user enrolled in a reward granting service that grants a reward in accordance with collection of the consumable component for recycling, grant the reward to the user;
when the obtained unique identification information of the device does not correspond to any device identification information associated with a user enrolled in the reward granting service, store the obtained unique identification information of the consumable component and of the device in the server-side storage unit; and
store, in the server-side storage unit, pre-enrollment reward information indicating rewards that are grantable in accordance with the consumable component corresponding to the obtained unique identification information of the consumable component, as a consumable component that was collected for recycling by the user of the device corresponding to the obtained device identification information, when the user enrolls in the reward granting service.

13. The consumable component management system according to claim 12,
wherein the consumable component consuming device further comprises a device-side display unit,
wherein the device-side control unit is configured to:
after the consumable component consuming device and the server are communicatively connected, transmit the device identification information to the server;
obtain, from the server, pre-enrollment reward information associated with the device identification information stored in the server-side storage unit; and
cause the device-side display unit to display the obtained pre-enrollment reward information.

14. The consumable component management system according to claim 12,
further comprising an external terminal,
wherein the external terminal comprises a terminal-side control unit and a terminal-side display unit,
wherein the terminal-side control unit is configured to:
after the external terminal and the server are communicatively connected, transmit the device identification information to the server;
obtain, from the server, pre-enrollment reward information associated with the device identification information stored in the server-side storage unit; and
cause the terminal-side display unit to display the obtained pre-enrollment reward information.
